(19) United States
(12) Patent Application Publication
(10) Pub. No.: US 2026/0204796 A1
(43) Pub. Date: Jul. 16, 2026

(54) ANTENNA RADIATOR AND MULTI-BAND ANTENNA COMPRISING SAME

(71) Applicant: Telefonaktiebolaget LM Ericsson (publ), Stockholm (SE)

(72) Inventor: Sertan Hastürkoglu, München (DE)

(21) Appl. No.: 19/138,329

(22) PCT Filed: Dec. 30, 2022
(86) PCT No.: PCT/EP2022/088066

§ 371 Date: Jun. 12, 2025

(51) Int. Cl. H01Q 15/00; H01Q 1/00; H01Q 1/24; H01Q 19/10; H01Q 21/26

(52) U.S. Cl. CPC H01Q 15/006; H01Q 1/002; H01Q 1/246; H01Q 19/108; H01Q 21/26

(57) ABSTRACT

There is described an antenna radiator comprising a radiator head and a radiator balun coupled to the radiator head. The radiator balun comprises a ground plane. The ground plane comprises a plurality of slots arranged in a microstrip line which is comprised in the ground plane.

### TECHNICAL FIELD

The present disclosure generally relates to an antenna radiator and a multi-band antenna comprising the antenna radiator.

### BACKGROUND

In base station antennas, efforts are made to develop the single radiators with a high gain/directivity. The following possibilities have thus far been available (without using parasitic elements) to achieve a higher directivity/gain: reducing the radiator height or enlarging the radiator head. The enlargement results in a larger aperture area so that a higher directivity/gain and lower Half Power Beam Width (HPBW) can be achieved.

Radiators (including, for example, dipoles) have a series and a parallel resonance. The parallel resonance has a high impedance. This high impedance may need to be transformed so that a good input reflection coefficient can be achieved. The transformation or matching circuit is made in the balun. This is possible by increasing the substrate height of the balun or decreasing the microstrip width. Decreasing the microstrip width allows for achieving a higher characteristic impedance. A narrow microstrip line can, however, not resist high power.

Existing solutions show that for matching full-wave dipoles—a schematic illustration of a full-wave dipole and its current distribution is shown in FIG. 1—which exhibit a high impedance behavior, a thicker substrate is used in the balun. This, however, affects the cost in the antenna (see, e.g., C. Ding, B. Jones, Y. J. Guo and P.-Y. Qin, “Wideband Matching of Full-Wavelength Dipole With Reflector for Base Station,” in IEEE Transactions on Antennas and Propagation, vol. 65, no. 10, pp. 5571-5576, October 2017). A defected ground structure may be used to create a filter characteristic. A square defected ground structure with stubs therein may be used to have a better bandgap characteristic. In other examples, a rectangular defected ground structure is used to achieve a filter characteristic. The microstrip lines are interrupted and capacitively connected within the defected ground structure.

### SUMMARY

The inventors have realized the need for an improved antenna radiator which addresses the above-identified problems of a thick (e.g. thicker than 0.8 mm) substrate and/or a narrow (e.g. narrower than 0.8 mm) microstrip, resulting in limitations relating to the maximum power and tolerances.

According to a first aspect, there is provided an antenna radiator comprising a radiator head and a radiator balun coupled to the radiator head. The radiator balun comprises a ground plane, wherein the ground plane comprises a plurality of slots arranged in a microstrip line which is comprised in the ground plane. The plurality of slots being arranged in the microstrip line may, in some examples, entail the plurality of slots being arranged below (in particular adjacent to) the microstrip line. Providing the plurality of slots in the microstrip line may in particular allow for a high impedance of a microstrip line which may be implemented in the ground plane. A high impedance microstrip line may thus be achieved, which can resist power above a predefined threshold (e.g. above 5 to 10 W per radiator). An increased thickness of the substrate may hereby be avoided.

In some examples of the antenna radiator, the slots are arranged in a center region of the microstrip line.

In some examples of the antenna radiator, the microstrip line has a constant microstrip line width. Decreasing the width of the microstrip line may thus not be needed in view of the slots being provided in the microstrip line.

In some examples, the antenna radiator comprises a full-wave dipole. A full-wave dipole has a relatively high impedance (e.g. more than 80 Ohms). Therefore, providing slots in the ground plane is particularly suitable for a full-wave dipole, as the high-impedance antenna radiators may be matched particularly well. The full-wave dipole generally has a high input impedance. Therefore, for the quarterwave transformation, one needs a typical impedance as the square root of the impedance of the input line (typically 50 to 75 Ohms) and the radiator feedpoint impedance, which can be, for example, as high as 100 to 400 Ohms. The head impedance of a full-wave dipole may be about 400 Ohms. Accordingly, the characteristic impedance of the microstrip line may be about 130 to 140 Ohms, for example 136 Ohms. As the microstrip line width provides for a limitation due to passive intermodulation (PIM) and input power, multiple slots may be required for matching.

In some examples, the antenna radiator has a de-scattering behavior. Providing the slots in the ground plane (in particular the microstrip line) allows for an improved de-scattering behavior of antenna radiators and makes it possible to integrate different multi-band antenna radiators in one multi-band antenna system without loss of performance. This means that the de-scattering radiator appears transparent for higher frequencies and other radiators for higher frequency bands can be arranged below it. A better de-scattering behavior of radiators brings a higher head impedance. Since a higher head impedance can be matched with the approach described herein, better transparency/de-scattering behavior can also be achieved. A right balance between transparency and matching may need to be found in the development of transparent radiator heads.

In some examples, the antenna radiator is configured to emit an electromagnetic wave at a wavelength, λ, whereby a slot length of any one of the plurality of slots in a first direction, the first direction being perpendicular to a second direction in which the radiator head generally extends, is less than λ/2. This allows for avoiding resonant characteristics of the antenna radiator.

In some examples, the antenna radiator is configured to emit an electromagnetic wave at a wavelength, λ, whereby a dimension of any one of the plurality of slots in any direction of the ground plane is less than λ/2. This allows for avoiding resonant characteristics of the antenna radiator in relation to electromagnetic waves traveling in different directions (noting that resonances may occur independently from the orientation of the slot(s)).

In some examples, the slots are arranged in a row in a first direction perpendicular to a second direction in which the radiator head generally extends. Providing the slots in a row allows for a simpler handling of simulations. On the other hand, deviations from a row (e.g. a statistical deviation from a center of the ground plane, or different sizes of the slots) are also possible.

There is further provided a multi-band antenna which is configured to emit electromagnetic waves at multiple wavelengths. The multi-band antenna comprises an antenna radiator according to any one of the example implementations as described herein.

In some examples, the antenna is a dual polarized antenna with two orthogonal polarizations, especially with linear polarizations of +/−45°.

In some examples, the multi-band antenna further comprises a reflector on which the antenna radiator is arranged. A slot length, in a direction perpendicular to the reflector, of any one of the plurality of slots is less than half of a smallest one of the multiple wavelengths. This allows for avoiding resonant characteristics of the multi-band antenna.

In some examples, a dimension of any one of the plurality of slots in any direction of the ground plane is less than half of a smallest one of the multiple wavelengths. This allows for avoiding resonant characteristics of the multi-band antenna in relation to electromagnetic waves traveling in different directions, as outlined above.

Example implementations as described herein may be used in particular in base station antennas. The radiators may, in some examples, be dual-polarized. The technique is suitable in particular for full-wave dipoles or dipoles which have a high head impedance.

### BRIEF DESCRIPTION OF THE DRAWINGS

Further aspects, details and advantages of the present disclosure will become apparent from the detailed description of exemplary embodiments below and from the drawings, wherein:

FIG. 1 shows a schematic illustration of a full-wave dipole and its current distribution according to the state of the art;

FIG. 2 shows an equivalent circuit diagram of a full-wavelength dipole or radiator with a de-scattering behavior;

FIGS. 3a and b show schematic illustrations of a balun and radiator according to some example implementations as described herein;

FIGS. 4a and b show schematic illustrations of slots in a microstrip line according to some example implementations as described herein;

FIGS. 5a and b show visualizations of the electric fields of the transmission line without and with slots in the ground plane, respectively; and

FIG. 6 shows a schematic block-diagram of a multi-band antenna according to some example implementations as described herein.

### DETAILED DESCRIPTION

In the following description, for purposes of explanation and not limitation, specific details are set forth in order to provide a thorough understanding of the present disclosure. It will be apparent to one of skill in the art that the present disclosure may be practiced in other embodiments that depart from these specific details.

Example implementations of an antenna radiator and a multi-band antenna described herein show how a high (e.g. above 80 to 100 Ohms) characteristic microstrip line impedance can be achieved with a small substrate thickness (e.g. below 0.7 to 1 mm, in particular below 0.8 mm). Slots are inserted into the ground plane, in some examples in the center of the microstrip line. The microstrip line can assume a high impedance with a constant microstrip line width.

A high impedance is generally present in full-wave dipoles or radiators with a de-scattering behavior. In order to match the radiators, the example implementations described herein can be used, which is a cost-effective solution in contrast to greater substrate thicknesses (e.g. above 0.8 mm).

Wideband matching of full wavelength dipoles is improved based on the slots being provided in the ground plane. Matching of antenna radiators which have a de-scattering behavior may also be improved.

Providing slots in the ground plane in the microstrip line provides for a cost-efficient implementation of a high characteristic microstrip impedance on a balun. The effect is that the de-scattering behavior of the radiator produces a full-wave dipole. The high head impedance can be matched with the method/examples described herein. It should be understood that a full-wave dipole is bigger than half a wavelength in its biggest extension (in any direction) of the radiator head.

A development cycle for matching a full-wave dipole or high-impedance radiator may comprise the following steps:
1) Creating the radiator head (e.g. full-wave dipole, etc.).
2) Designing a balun for the differential feed of the radiator and matching.
3) Designing of the base printed circuit board and cable interface.

In point 2) above, example implementations as described herein in which slots are provided in the ground plane can be used. The de-scattering behavior of antenna radiators is in trade-off between matching and transparency of the radiator. Better transparency is usually coupled with higher radiator impedance. The matching can be ensured with the example implementations as described herein. Slots in the ground plane of the balun allow a higher characteristic line impedance.

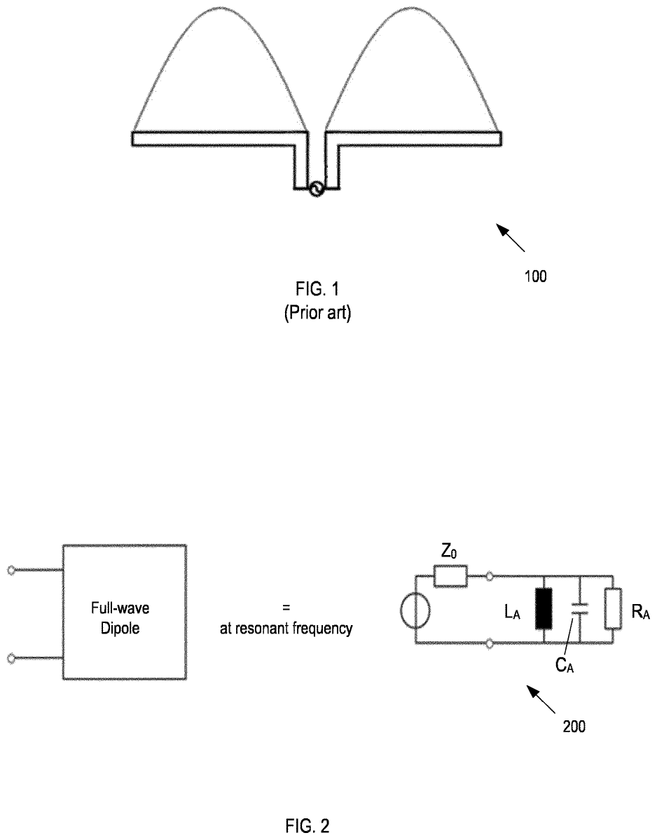

FIG. 2 shows an equivalent circuit diagram 200 of a full-wavelength dipole or radiator with a de-scattering behavior. These types of dipoles show a higher directivity or a transparent behavior in an interleaved antenna concept.

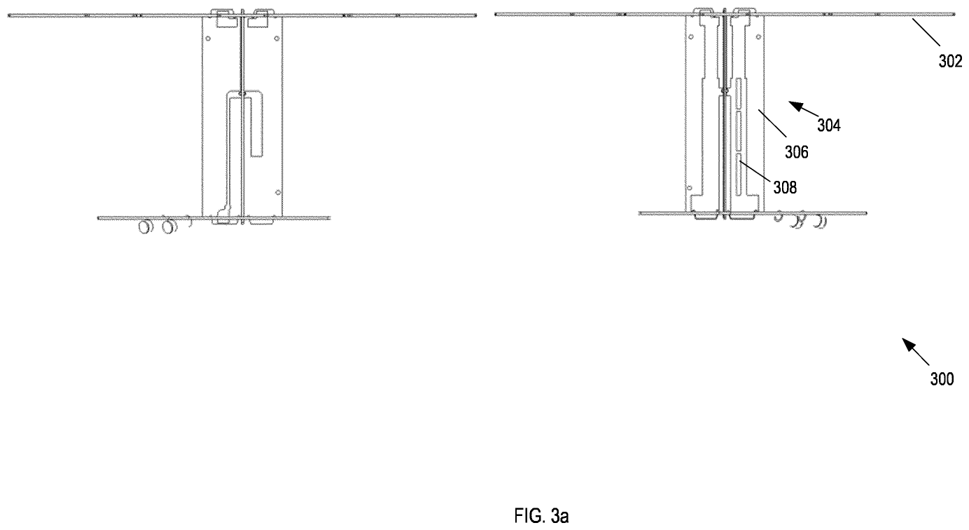

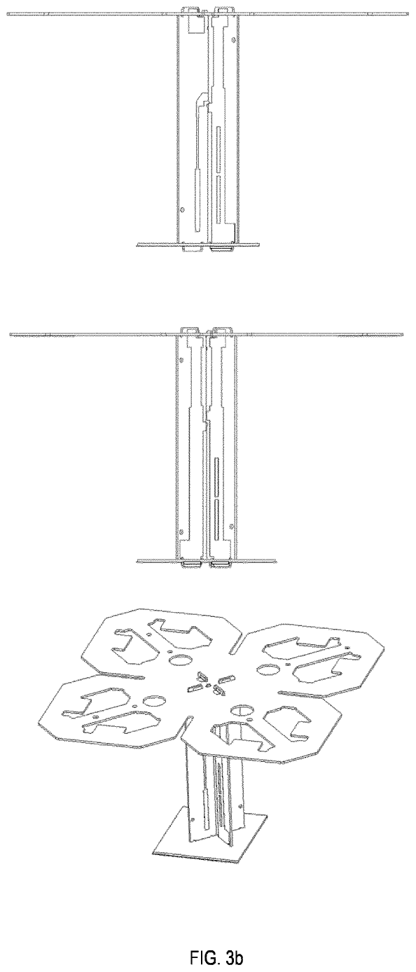

FIG. 3a shows a side view of a schematic illustration of an antenna radiator 300 with a radiator balun 304 according to some example implementations as described herein.

In this example, the antenna radiator comprises a radiator head 302 and a radiator balun 304 coupled to the radiator head 302. The radiator balun comprises a ground plane 306 comprising a plurality of slots 308. The slots 308 integrated in the radiator balun 304 allow for achieving a higher characteristic transmission/microstrip line impedance compared to when no slots were provided in the transmission/microstrip line.

Each slot is closed at a certain length (i.e. each slot has a maximum length, which may be dependent on the wavelengths/frequencies at which the antenna radiates electromagnetic waves), which shows no negative impact on the impedance transformation in the balun, i.e. resonances at any operational frequencies of the antenna. Preferably, the length of the slots is therefore smaller than half of the wavelength of any operating frequency of the antenna, including the other used frequencies in a multiband antenna.

FIG. 3b shows side views and a perspective view of a schematic illustration (CAD model) of an antenna radiator 300 (which may, in this case, be a low-band radiator) with the slotted ground area in the balun. The radiator head has a high impedance behavior, which can be matched with a high characteristic line impedance.

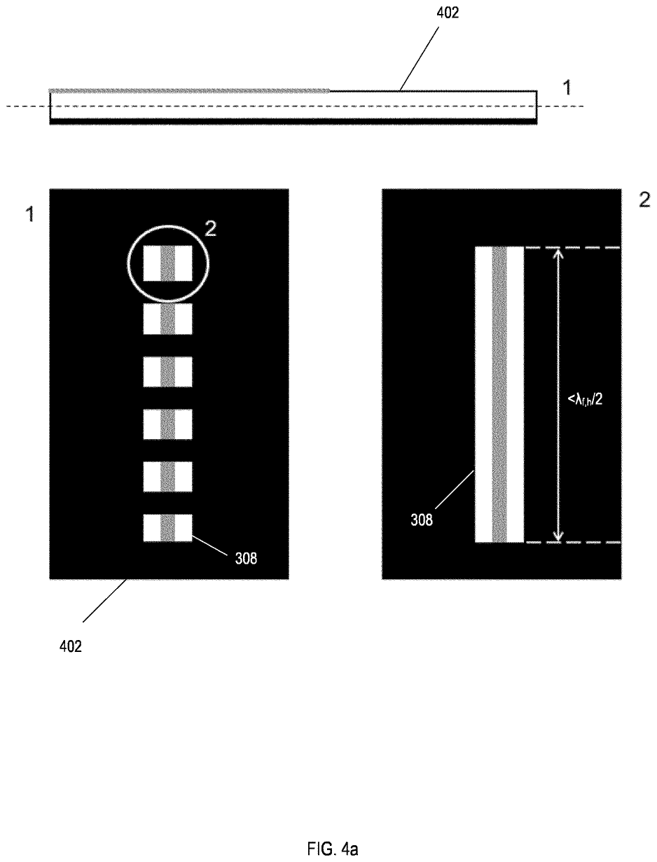

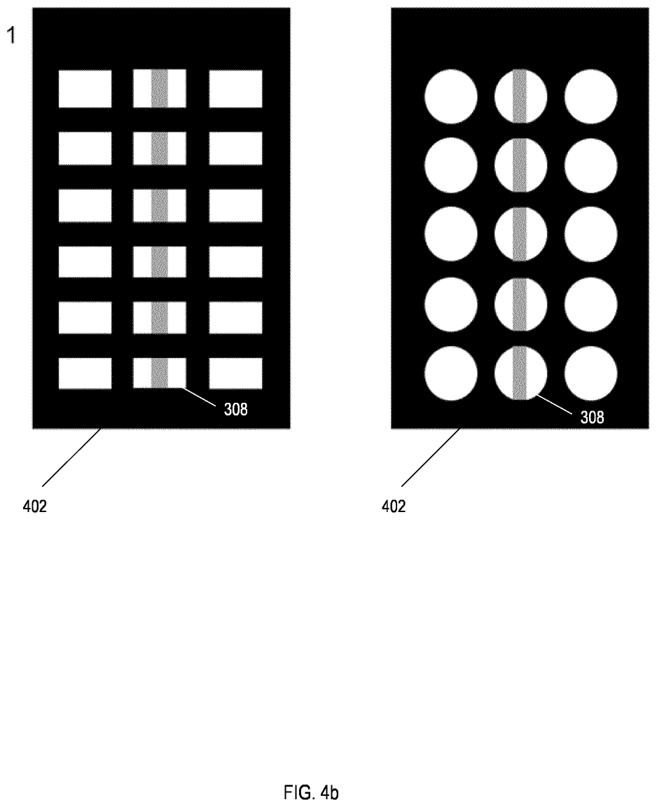

FIG. 4a shows a schematic illustration of slots 308 in a microstrip line 402 according to some example implementations as described herein.

The slot length is developed so that it is shorter than λ_{f_high}/2 (which is the smallest wavelength emittable by the multi-band antenna system, i.e. the wavelength corresponding to the highest frequency, f_high, emittable by the multi-band antenna system). This is advantageous because resonances can occur at higher frequencies, which may affect the S-parameters and far-field characteristics of the antenna radiators designed for the higher frequencies.

In this example, multiple slots 308 are arranged in a row on the microstrip line 402.

FIG. 4b shows schematic illustrations of slots 308 in a microstrip line 402 according to some example implementations as described herein. As can be seen, a grid of slots (rectangular, quadratic, circular, or other shapes) is possible to create a high characteristic impedance.

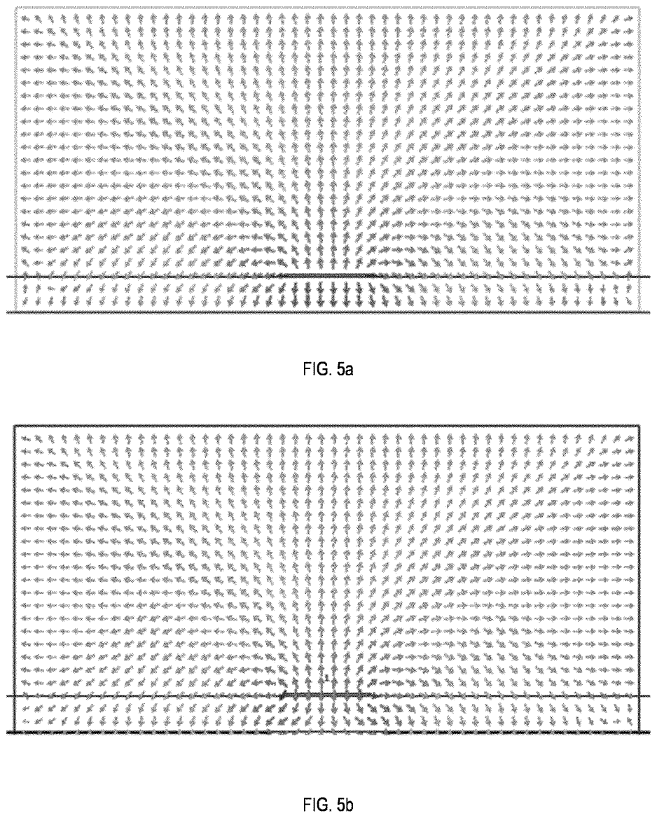

FIGS. 5a and b show visualizations of the electric field strength distribution of the transmission line without and with slots in the ground plane, respectively. A larger electric field strength can be observed in the visualization in FIG. 5b (with slots in the ground plane) around the transmission line compared to when no slots are provided in the ground plane (FIG. 5a).

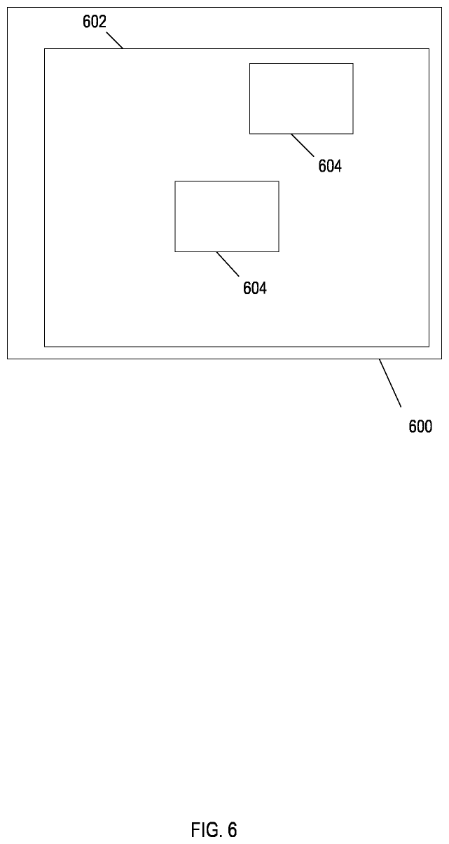

FIG. 6 shows a schematic block-diagram of a multi-band antenna 600 according to some example implementations as described herein.

The multi-band antenna 600 comprises a reflector 602 on which a plurality of antenna radiators 604 (which may be antenna radiators 300 shown in FIGS. 3a and/or b) are arranged.

With the slots provided in the ground plane, matching of high-impedance radiators (for example full wavelength dipoles or transparent radiators) may be improved.

An advantage of the example implementations as described herein is in particular a cost-effective implementation of high line impedance (e.g. above 80 to 100 Ohms) with a line width that can withstand the specified power levels (e.g. up to 200 W for a whole array or more than 5 to 10 W per radiator). In some examples, the solution does not show any resonant characteristics that could arise due to the slots, as their length is below λ_{f_high}/2.

Furthermore, a passive intermodulation (PIM)-safe implementation can be achieved by implementing the slots in the ground plane. It is hereby to be noted that investigations have shown that a minimum microstrip width of 1 mm is good for the PIM performance. However, the minimum microstrip width for radiators may, for example, be from 0.7 to 1 mm.

It will be appreciated that the present disclosure has been described with reference to exemplary embodiments that may be varied in many aspects. As such, the present invention is only limited by the claims that follow.

1. An antenna radiator comprising:
a radiator head; and
a radiator balun coupled to the radiator head;
wherein the radiator balun comprises a ground plane; and
wherein the ground plane comprises a plurality of slots arranged in a microstrip line which is comprised in the ground plane.

2. The antenna radiator of claim 1, wherein the slots are arranged in a center region of the microstrip line.

3. The antenna radiator of claim 1, wherein the microstrip line has a constant microstrip line width.

4. The antenna radiator of claim 1, wherein the antenna radiator comprises a full-wave dipole.

5. The antenna radiator of claim 1, wherein the antenna radiator has a de-scattering behavior.

6. The antenna radiator of claim 1, wherein the antenna radiator is configured to emit an electromagnetic wave at a wavelength (λ); and
wherein a slot length of any one of the plurality of slots in a first direction, the first direction being perpendicular to a second direction in which the radiator head generally extends, is less than λ/2.

7. The antenna radiator of claim 1, wherein the antenna radiator is configured to emit an electromagnetic wave at a wavelength (λ); and
wherein a dimension of any one of the plurality of slots in any direction of the ground plane is less than λ/2.

8. The antenna radiator of claim 1, wherein the slots are arranged in a row in a first direction perpendicular to a second direction in which the radiator head generally extends.

9. A multi-band antenna configured to emit electromagnetic waves at multiple wavelengths, wherein the multi-band antenna comprises:
a radiator head; and
a radiator balun coupled to the radiator head;
wherein the radiator balun comprises a ground plane; and
wherein the ground plane comprises a plurality of slots arranged in a microstrip line which is comprised in the ground plane.

10. The multi-band antenna of claim 9, further comprising a reflector on which the antenna radiator is arranged; and
wherein a slot length, in a direction perpendicular to the reflector, of any one of the plurality of slots is less than half of a smallest one of the multiple wavelengths.

11. The multi-band antenna of claim 9, wherein a dimension of any one of the plurality of slots in any direction of the ground plane is less than half of a smallest one of the multiple wavelengths.
